(19) United States
(12) Patent Application Publication
(10) Pub. No.: US 2006/0126111 A1
(43) Pub. Date: Jun. 15, 2006

(54) Network printing system to copy setting information and a method of copying setting information

(76) Inventors: Won-ho Song, Seoul (KR); Jae-kyung Cho, Suwon-si (KR)

Correspondence Address: STANZIONE & KIM, LLP, 919 18TH STREET, N.W., SUITE 440, WASHINGTON, DC, 20006, US

(21) Appl. No.: 11/282,672

(22) Filed: Nov. 21, 2005

(30) Foreign Application Priority Data
Dec. 9, 2004 (KR) 2004-103685

(51) Int. Cl. G06F 3/12

(52) U.S. Cl. 358/1.15

(57) ABSTRACT

A network printing system to copy setting information and a method of copying setting information. The network printing system comprises a source image forming apparatus to store setting information, at least one terminal to receive the setting information from the source image forming apparatus and to store the setting information if a command to copy the setting information is input, and a plurality of target image forming apparatuses to communicate with the at least one terminal to copy the setting information stored in the at least one terminal.

### CROSS-REFERENCE TO RELATED APPLICATIONS

This application claims the benefit under 35 U.S.C. § 119 from Korean Patent Application No. 2004-103685 filed on Dec. 9, 2004, in the Korean Intellectual Property Office, the disclosure of which is incorporated herein by reference in its entirety.

### BACKGROUND OF THE INVENTION

1. Field of the Invention

The present general inventive concept relates to a network printing system to copy setting information set in an image forming apparatus and a method thereof. More particularly, the present general inventive concept relates to a network printing system to copy setting information set in a source image forming apparatus to a plurality of target image forming apparatuses, and a method thereof.

2. Description of the Related Art

As personal computers (PCs) have been developed at a low cost with the development of PC manufacturing technology, computers have become widely popular. As a result, peripheral devices have also become popular very fast so as to use the computers more efficiently. The peripheral devices include image forming apparatuses, such as printers, scanners and multi-functional devices.

In particular, the image forming apparatuses provide various functions to increase flexibility and functionality. Thus, a user can freely select settings corresponding to states of the image forming apparatuses according to working environment characteristics and/or image forming operations to be performed. As a result, the image forming apparatuses perform the image forming operations according to setting information set by the user. In detail, the setting information may be default information regarding operation modes (e.g. a toner saving mode and a general mode), paper sizes (e.g. A4 and A3), paper feeding trays, etc. The image forming apparatuses, operating in the default operation mode or the general mode according to the setting information may feed printing paper sheets having designated sizes from designated paper feeding trays when printing.

Recently, network technology for connecting a plurality of PCs to a network has been used in various fields. When the plurality of PCs are connected to the network, a plurality of image forming apparatuses may be connected to the network so that users can use any of the plurality of image forming apparatuses. Thus, manufacturing companies of image forming apparatuses provide management programs enabling users to more efficiently manage the plurality of image forming apparatuses connected to the network. For example, the CentreWare Web program of FUJI XEROX, the OpenView Network Node Manage program of HEWLETT-PACKARD, the Web-SyncThru of SAMSUNG are types of management programs.

A user having a terminal connected to the network can execute a management program installed in the terminal to collect information regarding a type, a state, etc. about any image forming apparatus connected to the network. The user can select an image forming apparatus from among the image forming apparatuses connected to the network to perform a printing job.

When the setting information is set in an image forming apparatus, the same setting information may be set in another image forming apparatus having similar specifications as the image forming apparatus. In this case, the setting information may be copied through a copying function of the management program installed in the terminal so as to reduce a number of inputs necessary to set various types of setting information. The copying function is called a “clone function.” The management program used in the terminal has the clone function.

In a conventional network printing system, the user first executes the management program to collect information on types of image forming apparatuses connected to the network so as to use the clone function. Next, the user selects a source image forming apparatus and a target image forming apparatus from among the image forming apparatuses connected to the network. The terminal requests the setting information of the source image forming apparatus, receives the setting information from the source image forming apparatus, and transmits the setting information to the target image forming apparatus. Conventionally, the setting information transmission and reception between the source image forming apparatus and the terminal are performed using a TCP/IP protocol. When the user desires to copy the setting information to a plurality of target image forming apparatuses, the user must repeat the above-described method of copying the setting information individually for each of the plurality of target image forming apparatuses. This repetition is inconvenient to the user. Additionally, copying the setting information is typically time consuming. Since the network is used for a long time to copy the setting information to each of the target image forming apparatuses, a load on the network is increased.

### SUMMARY OF THE INVENTION

The present general inventive concept provides a terminal to manage copying setting information set in a source image forming apparatus to a plurality of target image forming apparatuses to reduce a setting information copying time and a load on a network, an image forming apparatus capable to function as a source image forming apparatus or a target image forming apparatus, a network printing system including the terminal and the image forming apparatus, and a method of copying setting information.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a network printing system including a plurality of image forming apparatuses connected to a network, the network printing system comprising a source image forming apparatus to store setting information, at least one terminal to receive the setting information from the source image forming apparatus and to store the received setting information if a command to copy the setting information is input, and a plurality of target image forming apparatuses to communicate in parallel with the at least one terminal to copy the setting information stored in the at least one terminal.

The at least one terminal may designate all image forming apparatuses of the plurality of image forming apparatuses having product property information that is substantially identical to product property information of the source image forming apparatus as the plurality of target image forming apparatuses and transmit the setting information to the target image forming apparatuses.

The at least one terminal may display a list of image forming apparatuses having product property information that is substantially identical to product property information the source image forming apparatus on a screen, designate image forming apparatuses selected in the list as the target image forming apparatuses, and transmit the setting information to the target image forming apparatuses.

The at least one terminal may store the setting information in a host memory and transmit address information indicating an area of the host memory storing the setting information to the target image forming apparatuses so that the target image forming apparatuses read the setting information from the host memory.

The target image forming apparatuses may communicate with the at least one terminal by multicasting using a Service Location Protocol, a Service Network Management Protocol, or a Common Network Management Protocol.

The foregoing and/or other aspects of the present general inventive concept may also be achieved by providing a terminal in communication with a plurality of image forming apparatuses through a network, the terminal comprising a user interface to input a command to copy setting information from a source image forming apparatus, a communicator to request the setting information of the source image forming apparatus via the network and to receive the setting information from the source image forming apparatus, a host memory to store the received setting information, and a central processing unit to select a plurality of target image forming apparatuses and to control the communicator to transmit the setting information stored in the host memory to the plurality of target image forming apparatuses.

The central processing unit may collect product property information of each of the plurality of image forming apparatuses in the network to designate all of image forming apparatuses having product property information that is substantially identical to product property information of the source image forming apparatus as the plurality of target image forming apparatuses.

The terminal may further comprise a display to display a list of the all of the image forming apparatuses having the product property information that is substantially identical to product property information of the source image forming apparatus. Here, the central processing unit may designate image forming apparatuses selected from the displayed list as the plurality of target image forming apparatuses.

The central processing unit may control the communicator to transmit address information indicating an area of the host memory storing the setting information to the plurality of target image forming apparatuses so that the target image forming apparatuses to read the setting information from the host memory according to the address information.

The setting information may be transmitted to the plurality of target image forming apparatuses by multicasting using a Service Location Protocol, a Service Network Management Protocol, or a Common Network Management Protocol.

The foregoing and/or other aspects of the present general inventive concept may also be achieved by providing an image forming apparatus in communication with a terminal of a predetermined type via a network, the apparatus comprising a network interface to transmit and to receive predetermined data via the network, a memory to store first setting information, and a data processor to generate a first data file including the first setting information and having a predetermined format and to control the network interface to transmit the first data file to the terminal if the network interface receives a request from the terminal designates the image forming apparatus as a source image forming apparatus.

If a request received from the terminal designates the image forming apparatus as a target image forming apparatus, the data processor may receive a second data file from the terminal, parse the second data file to detect second setting information, replace the first setting information with the second setting information, and store the second setting information in the memory.

The first and second data files may be written in one of an extensible Markup Language, a Web Services Description Language, a HyperText Markup Language, or a Standard Generalized Markup Language.

The network interface may communicate with the terminal by multicasting using one of a Service Location Protocol, a Service Network Management Protocol, and a Common Network Management Protocol.

The foregoing and/or other aspects of the present general inventive concept may also be achieved by providing a method of copying setting information in a network printing system comprising, the method comprising selecting a source image forming apparatus from a plurality of image forming apparatuses of the network printing system, requesting setting information of the source image forming apparatus, storing the setting information received from the source image forming apparatus in a host memory, designating one or more of the plurality of image forming apparatuses as target image forming apparatuses, and communicating with the one or more target image forming apparatuses to transmit the setting information.

The designating of the one or more of the plurality of image forming apparatuses as the target image forming apparatuses may comprise collecting product property information of each of the plurality of image forming apparatuses in the network printing system, and designating image forming apparatuses of the plurality of image forming apparatuses having product property information that is substantially identical to product property information of the source image forming apparatus as the one or more target image forming apparatuses.

The designating of the one or more of the plurality of image forming apparatuses as the target image forming apparatuses may comprise displaying a list of image forming apparatuses having product property information that is substantially identical to product property information of the source image forming apparatus on a screen, and selecting one or more image forming apparatuses from the list as the target image forming apparatuses.

The communicating with the one or more target image forming apparatuses to transmit the setting information may comprise transmitting address information indicating an area of the host memory in which the setting information is stored to the one or more target image forming apparatuses, and enabling the one or more target image forming apparatuses to read the setting information from the host memory of the terminal according to the address information.

The setting information may be information recorded in a data file written in one of an extensible Markup Language, a Web Services Description Language, a HyperText Markup Language, or a Signed Document Markup Language.

The terminal may communicate with the one or more target image forming apparatuses by multicasting using one of a Service Location Protocol, a Service Network Management Protocol, and a Common Network Management Protocol.

The foregoing and/or other aspects of the present general inventive concept may also be achieved by providing a computer readable recording medium having executable codes to perform a method of copying setting information, the method including selecting a source image forming apparatus from a plurality of image forming apparatuses connected to a network, requesting the setting information of the source image forming apparatus, receiving the setting information from the source image forming apparatus, designating at least two of the plurality of image forming apparatuses as target image forming apparatuses, and communicating with the at least two target image forming apparatuses to transmit the setting information.

The foregoing and/or other aspects of the present general inventive concept may also be achieved by providing a network printing system including a plurality of image forming apparatuses, each having setting information, to provide the setting information upon request, and to replace the setting information with new setting information when the new setting information is received, and a management unit in communication with the plurality of image forming apparatuses to select a source image forming apparatus from the plurality of image forming apparatuses, to request the setting information from the source image forming apparatus, to select one or more target image forming apparatuses from the plurality of image forming apparatuses, and to provide the setting information of the source image forming apparatus to the one or more target image forming apparatuses.

The foregoing and/or other aspects of the present general inventive concept may also be achieved by providing a management module to manage image forming apparatuses of a network printing system, the management module including a user interface to display menus and lists of the image forming apparatuses, to select image forming apparatuses from the displayed lists, and to input commands according to the displayed menus, a network interface to communicate with the image forming apparatuses, and a controller to request setting information from a designated image forming apparatuses, to select two or more image forming apparatuses from the plurality of image forming apparatuses to simultaneously provide the setting information of the designated image forming apparatus to the two or more selected image forming apparatuses.

The foregoing and/or other aspects of the present general inventive concept may also be achieved by providing a management module to manage image forming apparatuses of a network printing system, the management module including a controller to copy a group of image forming apparatus settings from a source image apparatus to a group of target image forming apparatuses in parallel.

The foregoing and/or other aspects of the present general inventive concept may also be achieved by providing an image forming apparatus connected to a network having a plurality of image forming apparatus, the image forming apparatus including a controller to store current setting information, to provide the current setting information when requested by an external device, to receive new setting information in a packet according to a multicast protocol from the external device, to parse the new setting information from the packet, and to replace the current setting information with the new setting information.

The foregoing and/or other aspects of the present general inventive concept may also be achieved by providing a method of copying setting information to image forming apparatuses in a network printing system, the method including copying a group of image forming apparatus settings from a source image apparatus to a group of target image forming apparatuses in parallel.

The foregoing and/or other aspects of the present general inventive concept may also be achieved by providing a method of copying setting information to image forming apparatuses in a network printing system, the method comprising selecting an image forming apparatus in the network printing system to provide the setting information, identifying image forming apparatuses in the network printing system capable to operate according to the setting information of the selected image forming apparatus, and sending the setting information of the selected image forming apparatus to the identified image forming apparatuses using a multicast protocol.

The foregoing and/or other aspects of the present general inventive concept may also be achieved by providing a computer readable storage medium having executable codes to perform a method of copying setting information to image forming apparatuses in a network printing system, the method comprising selecting an image forming apparatus in the network printing system to provide the setting information, identifying image forming apparatuses in the network printing system capable of operating according to the setting information of the selected image forming apparatus, and to send the setting information of the selected image forming apparatus to the identified image forming apparatuses using a multicast protocol.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a network printing system according to an embodiment of the present general inventive concept;

FIG. 2 is a block diagram of a terminal of the network printing system of FIG. 1 according to an embodiment of the present general inventive concept;

FIG. 3 is a view of an interface window displayed on a screen of a terminal according to an embodiment of the present general inventive concept;

FIG. 4 is another view of the interface window displayed on a screen of a terminal according to an embodiment of the present general inventive concept;

FIG. 5 is a block diagram of an image forming apparatus of the network printing system of FIG. 1 according to an embodiment of the present general inventive concept;

FIG. 6 is a flowchart of a method of copying setting information according to r an embodiment of the present general inventive concept;

FIG. 7 is a flowchart of a method of copying setting information according to another embodiment of the present general inventive concept;

FIG. 8 is a flowchart of a method of processing setting information in a source image forming apparatus according to an embodiment of the present general inventive concept; and

FIG. 9 is a flowchart of a method of processing setting information in an image forming apparatus designated as a target image forming according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

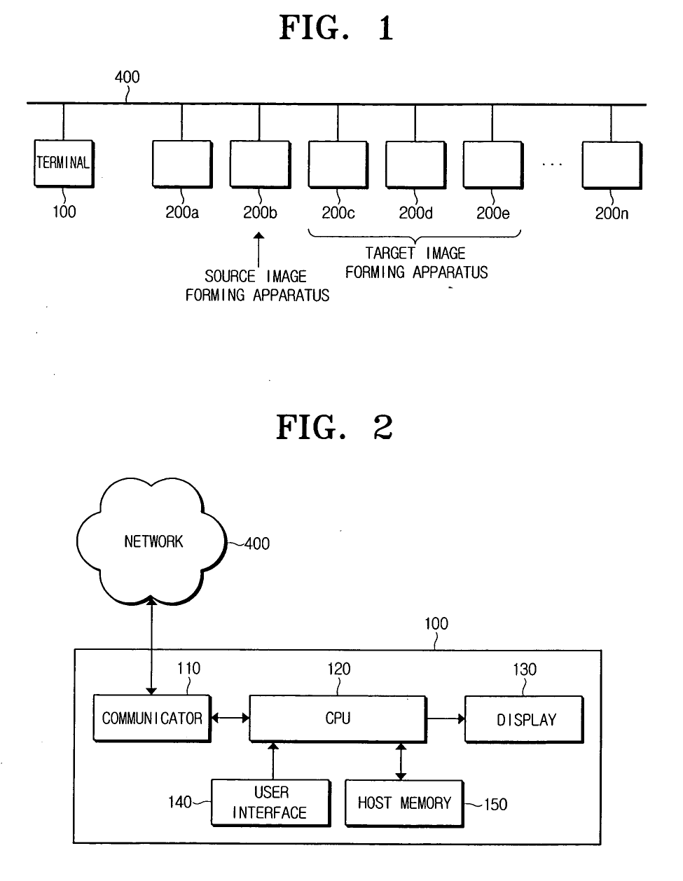

FIG. 1 is a block diagram of a network printing system according to an embodiment of the present general inventive concept. Referring to FIG. 1, a network printing system according to the present embodiment includes a terminal 100, a network 400, and a plurality of image forming apparatuses 200a through 200n. In the network printing system, the terminal 100 may be a desktop PC, a notebook PC, a personal digital assistance (PDA), or the like. The image forming apparatuses 200a through 200n may be printers, copiers, scanners, facsimiles, multi-functional devices, or the like. The network printing system includes at least one terminal, but may include more than one terminal.

The terminal 100 displays information relative to the image forming apparatuses 200a through 200n connected to the network 400 on a screen so that a user can view the information. The user can select a source image forming apparatus 200b from among the image forming apparatuses 200a through 200n. A command to copy setting information set in the source image forming apparatus 200b may then be input. Although FIG. 1 and the description that follows refer to the image forming apparatus 200b as the source and the image forming apparatuses 200c to 200e as the target, it should be understood that these descriptions are not intended to limit the scope of the present general inventive concept and are merely exemplary.

If the command to copy the setting information is input, the terminal 100 transmits a packet to the source image forming apparatus 200b to request a transmission of the setting information set in the source image forming apparatus 200b. The source image forming apparatus 200b generates a data file having a predetermined format including the setting information stored in a memory thereof and transmits the data file to the terminal 100.

The terminal 100 searches among the plurality of image forming apparatuses 200a and 200c through 200n (i.e. the image forming apparatuses other than the source image forming apparatus 200b) for target image forming apparatuses to which the setting information set in the source image forming apparatus 200b is to be copied. Here, the method of searching for the target image forming apparatuses varies in different embodiments of the present general inventive concept.

According to an embodiment of the present general inventive concept, the terminal 100 collects product property information relative to the image forming apparatuses 200a through 200n connected to the network 400. Thus, if the terminal 100 searches for image forming apparatuses having product property information that is the same as product property information of the source image forming apparatus 200b, the terminal 100 may designate all the image forming apparatuses having same product property information as the target image forming apparatuses, for example 200a and 200c through 200n. The product property information may include manufacturing company names, types of products, series model names, etc. In a case of image forming apparatuses having an identical series model developed by the same company, a series number of the identical series model may be different. However, functionality of the image forming apparatuses having the identical series model does not vary, and thus the image forming apparatuses may operate according to the same setting information. Thus, if according to the collected information, an image forming apparatus has a manufacturing company name and a series model name identical to the source image forming apparatus, the image forming apparatus having the identical series model may be designated as a target image forming apparatus. Also, although an image forming apparatus having a different product type (i.e., as indicated by the product property information) may receive the setting information of the source image forming apparatus, the image forming apparatus having the different product type may not be able to operate according to the received setting information. Thus, whether the product type of image forming apparatus having the different product type is substantially identical to the source image forming apparatus 200b may be determined by design, specifications and/or decided by the user. In other words, when a first image forming apparatus has product property information substantially identical to product property information of a second image forming apparatus, the first and second image forming apparatuses can operate according to the same setting information. That is, the first image forming apparatus may be the source image forming apparatus and the second image apparatus may be the target image forming apparatus, or vice versa.

According to another embodiment of the present general inventive concept, a list of the image forming apparatuses 200a through 200n connected to the network 400 may be displayed so that the user can select the target image forming apparatuses. In this case, as described above, based on the product property information of the image forming apparatuses 200a through 200n, the list may include only the image forming apparatuses that can copy and use the setting information. Thus, the image forming apparatuses selected from the list by the user are designated as the target image forming apparatuses 200c through 200e.

The terminal 100 transmits the data file received from the source image forming apparatus 200b to the target image forming apparatuses 200c through 200e by multicasting. A multicast protocol allows one source (the terminal) to send data to many destinations (the target image forming apparatuses). In this case, the terminal 100 may transmit the data file to the target image forming apparatuses 200c through 200e using one of a Service Location Protocol (SLP), a Service Network Management Protocol (SNMP), and a Common Network Management Protocol (CNMP). Other protocols may also be used. Thus, the terminal 100 does not need to separately transmit the data file to each of the target image forming apparatuses 200c through 200e. As a result, an amount of time required to transmit the setting information is reduced.

When the target image forming apparatuses 200c through 200e receive the data file from the terminal 100, the target image forming apparatuses 200c through 200e parse the data file to detect the setting information. Thus, preset setting information stored in the target image forming apparatuses' memory is replaced with the detected (new) setting information. For example, A4 may have been previously set as a default paper format of a target image forming apparatus, but B4 may be set as the default paper format according to the new setting information, so that B4 is newly set as the default paper format. Default values with respect to the paper feeding trays, an operation mode, a toner mode, and the like may also be changed according to the new setting information.

FIG. 2 is a block diagram of the terminal 100 used in the network printing system illustrated in FIG. 1. Referring to FIG. 2, the terminal 100 includes a communicator 110, a central processing unit (CPU) 120, a display 130, a user interface 140, and a host memory 150.

The communicator 110 transmits and receives (i.e. communicates) data via the network 400. The communicator 110 may communicate with a predetermined image forming device connected to the network 400, or may send data (in a packet) to more than one image forming apparatus when using a multicast protocol as described above.

In the CPU 120, a management program to manage the image forming apparatuses 200a through 200n connected to the network 400 is installed. When the management program is executed, the CPU 120 generates an interface window corresponding to the management program.

The display 130 displays the interface window of the management program on a screen.

The user interface 140 allows the user to input commands and make selections based on displayed menus. When the user selects various menu buttons on the interface window displayed on the screen using a mouse, a touch screen, or the like, the user interface 140 recognizes the selected menu buttons and informs the CPU 120 of the selected menu buttons.

The host memory 150 stores various types of data received via the communicator 110. The communicator 110 may be a communication interface.

The CPU 120 displays information relative to the image forming apparatuses 200a through 200n connected to the network 400 on the interface window in the form of a list. The user may select the source image forming apparatus 200b from the list and input a command to copy the setting information of the source image forming apparatus 200b.

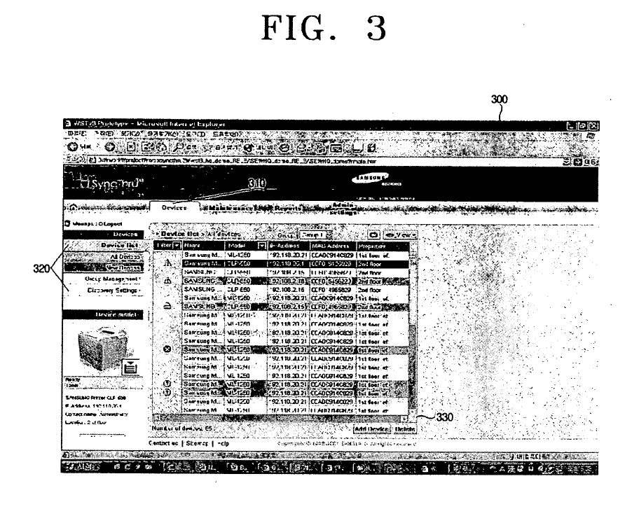

FIG. 3 is a schematic view of an interface window 300 displayed on the screen of the display 130 of the terminal 100 according to an embodiment of the present general inventive concept. Referring to FIG. 3, higher menus 310, such as “Devices,” “Maintenance,” “Reports,” “Admin Settings,” and the like, are displayed on a top portion of the interface window 300. The higher menus 310 may include tabs. When one of the higher menus 310 is selected, lower menus 320 subordinate to the selected higher menu 310 are displayed in a lateral area of the interface window 300. As illustrated in FIG. 3, if “Devices” is selected from the higher menus 310, the user may select “Devices list” from the lower menus 320 to display a list of image forming apparatuses connected to the network 400. Thus, a device list 330 including a manufacturing company name, a model name, an Internet Protocol (IP) address, a Media Access Control (MAC) address, position information, and the like of each of the image forming apparatuses connected to the network 400 is displayed on the interface window 300.

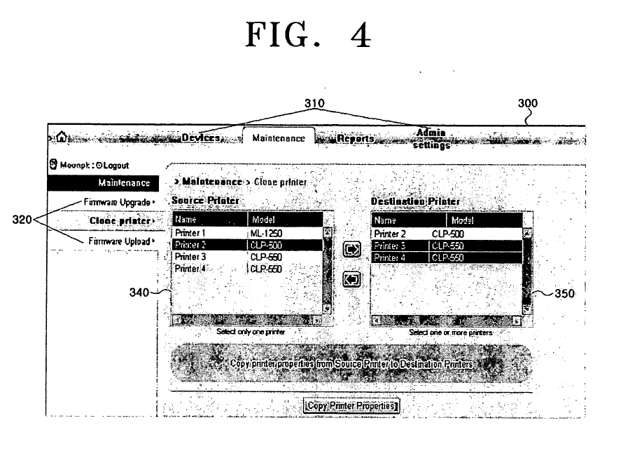

FIG. 4 is a detailed view of a configuration of the interface window 300 when “Maintenance” is selected from the higher menus 310. If the user selects “Maintenance” to manage the image forming apparatuses 200a through 200n from the higher menus 310, in the interface window 300 lower menus 320 corresponding to “Maintenance” are displayed in the interface window 300 as illustrated in FIG. 4. In other words, the lower menus 320 subordinate to “Maintenance,” (i.e., “Firmware Upgrade,” “Clone printer,” and “Firmware upload”) are displayed. If a “Clone printer” button is selected from the lower menus 320, a source image forming apparatus selection area 340 and a target image forming apparatus selection area 350 are displayed in the interface window 300. The user may move a cursor in the source image forming apparatus selection area 340 to select the source image forming apparatus. The user may also select one or more target image forming apparatuses in the target image forming apparatus selection area 350.

The interface window 300, as illustrated in FIG. 4, allows the user to select any target image forming apparatus. Alternatively, all image forming apparatuses capable of copying the setting information from the terminal 100 may be searched and automatically designated as target image forming apparatuses, and in this case, the target image forming apparatus selection area 350 may not be displayed.

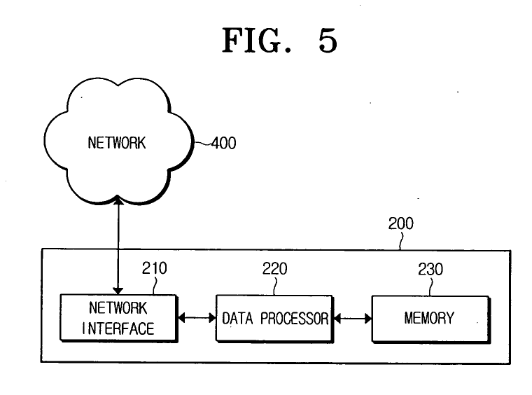

FIG. 5 is a block diagram of an image forming apparatus 200 of the image forming apparatuses 200a through 200n used in the network printing system illustrated in FIG. 1, according to an embodiment of the present general inventive concept. Referring to FIG. 5, the image forming apparatus 200 includes a network interface 210, a data processor 220, and a memory 230.

The network interface 210 communicates with the terminal 100 via the network 400. The network interface 210 may be a network interface card (NIC).

The data processor 220 generates a data file in a predetermined language including the setting information of the image forming apparatus 200, and parses a received data file including new setting information to detect the new setting information.

The memory 230 stores the setting information (i.e. the setting information that is currently set) used by the image forming apparatus to perform printing jobs and/or image forming operations.

When the image forming apparatus 200 is designated as the source image forming apparatus, the network interface 210 receives a packet from the terminal 100 to request the setting information of the image forming apparatus 200 and informs the data processor 220 of the request.

The data processor 220 reads the setting information from the memory 230 and generates a data file including the read setting information using a predetermined language. Here, the predetermined language may be an eXtensible Markup Language (XML), a Web Services Description Language (WSDL), a HyperText Markup Language (HTML), a Signed Document Markup Language (SDML), etc.

The network interface 210 transmits the generated data file to the terminal 100 via the network 400.

When the image forming apparatus 200 is designated as the target image forming apparatus, the network interface 210 communicates with the terminal 100 in a multicast manner using a predetermined protocol. As described above, the predetermined protocol may be an SLP, an SNMP, a CNMP, etc. However, the predetermined protocol is not limited to these protocols but may be another multicast protocol. A multicast protocol allows one source (the terminal) to send data to many destinations (the target image forming apparatuses).

Thus, if the data processor 220 receives a data file including setting information set in the source image forming apparatus via the network interface 210, the data processor 220 parses the data file to detect the setting information. In detail, when the data file is an XML file, the data processor 220 may include an XML parser.

The data processor 220 stores the detected setting information in the memory 230. In this case, pre-stored setting information is replaced with the detected setting information. As a result, the setting information of the source image forming apparatus is copied to the image forming apparatus 200.

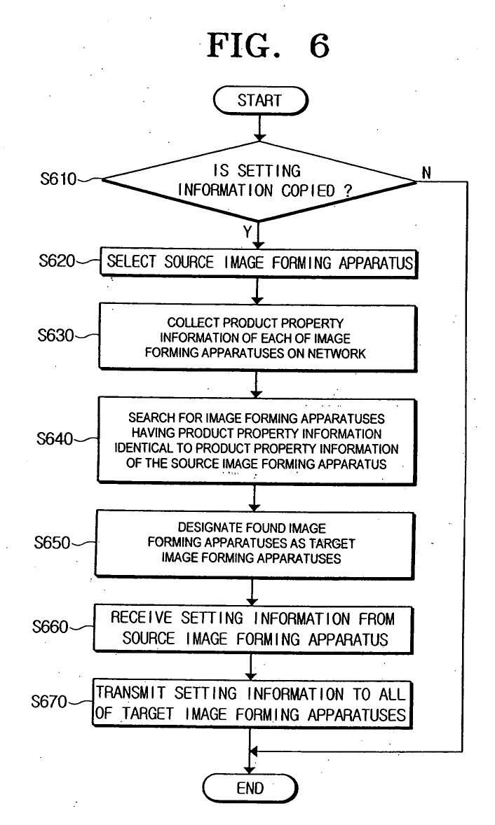

FIG. 6 is a flowchart of a method of copying setting information in a network printing system according to an embodiment of the present general inventive concept. The method of FIG. 6 may be performed by the network system of FIG. 1. Accordingly, the method of FIG. 6 is described bellow with reference to FIGS. 1 through 6, but it is not limited thereby. Referring to FIG. 6, in operation S610, the CPU 120 determines whether a setting information copy function is selected on the terminal 100. In operation S620, the source image forming apparatus 200b is selected. In operation S630, the terminal 100 collects product property information of the image forming apparatuses 200a and 200c through 200n except for the source image forming apparatus 200b connected to the network 400. That is, the terminal 100 collects the product property information of the image forming apparatuses 200a and 200c through 200n but not the product property information of the source image forming apparatus 200b. As described above, the selections of the setting information copy function and the source image forming apparatus 200b may be provided via the interface window 300 displayed on the screen of the terminal 100. Also, the interface window may be generated by a predetermined management program. Examples of management programs that may be used as the predetermined management program include the CentreWare Web management program of HUJI XEROX, the OpenView Network Node Manager program of HEWLETT-PACKARD, the Wet-SyncThru program of SAMSUNG.

In operation S640, the terminal 100 searches for image forming apparatuses having the same product property information as the source image forming apparatus 200b from among the image forming apparatuses 200a and 200c through 200n. In operation S650, the terminal 100 designates image forming apparatuses 200c through 200e as the target image forming apparatuses. As set forth above, it should be understood the designation in FIG. 1 of 200b as the source image forming apparatus and 200c through 200e as the target image forming apparatuses are merely exemplary. Other designations may also be used.

In operation S660, the terminal 100 requests the setting information from the source image forming apparatus 200b to send a setting information data file generated in a predetermined language. In operation S670, the terminal 100 transmits the setting information data file received from the source image forming apparatus 200b to all of the target image forming apparatuses 200c through 200e by multicasting.

A manner of transmission of the setting information data file may be varied in each of embodiments of the present general inventive concept. In other words, according to an embodiment of the present general inventive concept, the setting information data file may be immediately transmitted.

Alternatively, the terminal 100 may store the setting information data file in the host memory 150 and may transmit only address information indicated an area of the host memory 150 storing the setting information data file so that the target image forming apparatuses 200c through 200e can read the setting information data file from the corresponding area according to the address information.

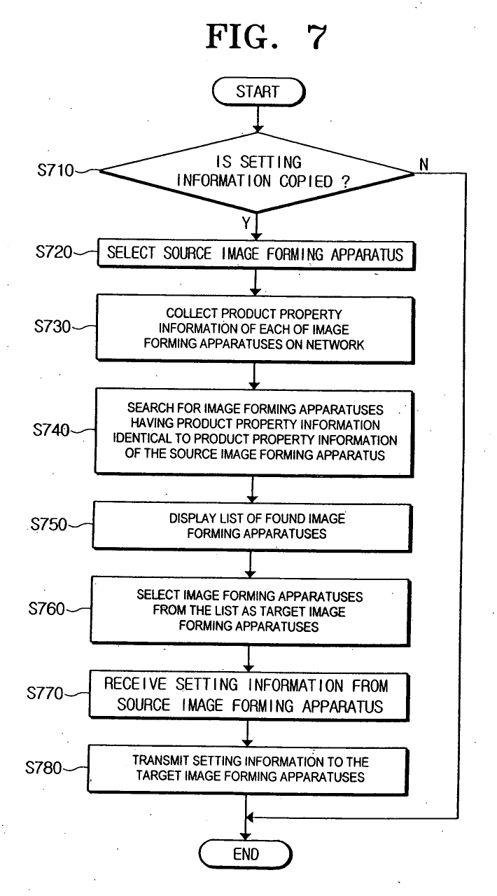

FIG. 7 is a flowchart of a method of copying setting information in a network printing system according to another embodiment of the present general inventive concept. The method of FIG. 7 may be performed by the network system of FIG. 1. Accordingly, the method of FIG. 7 is described bellow with reference to FIGS. 1 through 5 and 7, but it is not intended to be limited thereby. Referring to FIG. 7, in operation S710, the CPU 120 determines whether the setting information copy function is selected. In operation S720, the source image forming apparatus 200b is selected. In operation S730, product property information of the image forming apparatuses 200a and 200c through 200n except the source image forming apparatus 200b on the network 400 is collected. In operation S740, image forming apparatuses having same product property information as the source image forming apparatus 200b are searched for.

In operation S750, the terminal 100 displays a list of the image forming apparatuses that are found to have the same product property information as the source image forming apparatus 200b on the screen so that the user can select the target image forming apparatuses from the list. Thus, if the user selects image forming apparatuses, in operation S760, the terminal 100 designates the selected image forming apparatuses as the target image forming apparatuses (for example, 200c through 200e). In operation S770, the terminal 100 receives the setting information from the source image forming apparatus 200b. In operation S780, the terminal 100 transmits the received setting information to the target image forming apparatuses 200c through 200e.

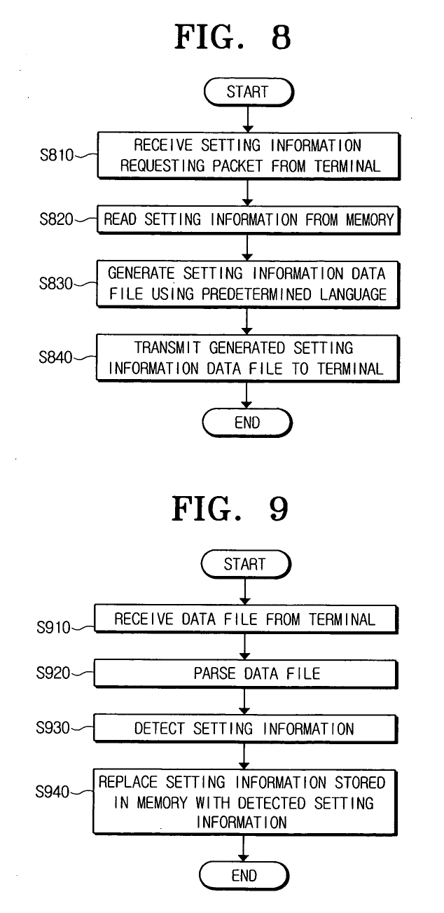

FIG. 8 is a flowchart of a method of processing setting information in the source image forming apparatus 200b selected from the image forming apparatuses 200a through 200n connected to the network 400. Referring to FIG. 8, in operation S810, the source image forming apparatus 200b receives a setting information requesting packet from the terminal 100. In operation S820, the source image forming apparatus 200b reads the setting information that is pre-stored in the memory 230. In operation S830, the source image forming apparatus 200b generates a data file including the read setting information in a predetermined language. The source image forming apparatus 200b transmits the data file to the terminal 100. The predetermined language may be an XML, an SDML, a WSDL, a HTML, or the like, and the data file may be transmitted using a protocol such as an SLP, an SNMP, a CNMP, or the like.

FIG. 9 is a flowchart of a method of processing setting information in image forming apparatuses designated as the target image forming apparatuses 200c through 200e from among the image forming apparatuses 200a and 200c through 200n. Referring to FIG. 9, in operation S910, the target image forming apparatuses 200c through 200e receive a data file from the terminal 100. In operation S920, the target image forming apparatuses 200c through 200e parse the data file according to the predetermined language used to generate the data file.

In operation S930, the setting information included in the data file is detected. In operation S940, setting information pre-stored in the memory 230 is replaced with the detected setting information. Thus, if a user selects one of the target image forming apparatuses 200c through 200e to perform an image forming operation, the selected image forming apparatus operates according to the detected setting information.

The above-described method of copying setting information can also be embodied as computer readable codes on a computer readable recording medium. Examples of the computer readable recording medium include a magnetic recording medium such as a floppy disc, a hard disc, and the like, an optical recording medium such as a CD, a DVDs and the like, and various types of media such as a memory card, a holographic storage medium, and the like. Computer readable codes stored in such a recording medium, i.e., a program, can be read by a terminal so as to execute the method of copying setting information.

As described above, in a network printing system to copy a setting information and a method of copying setting information according to the present general inventive concept, the network printing system includes a plurality of image forming apparatuses. Setting information set in a source image forming apparatus can be simultaneously copied to a plurality of target image forming apparatuses using a multicast protocol. Thus, a user can reduce times and efforts required for separately copying the setting information to the target image forming apparatuses. Also, a load on the network printing system caused by a several operations of copying the setting information can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A network printing system including a plurality of image forming apparatuses connected to a network, the system comprising:
a source image forming apparatus to store setting information;
at least one terminal to receive the setting information from the source image forming apparatus and to store the received setting information if a command to copy the setting information is input; and
a plurality of target image forming apparatuses to communicate in parallel with the at least one terminal to copy the setting information stored in the at least one terminal.

2. The network printing system of claim 1, wherein the at least one terminal designates all image forming apparatuses of the plurality of image forming apparatuses having product property information that is substantially identical to product property information of the source image forming apparatus as the plurality of target image forming apparatuses and transmits the setting information to the target image forming apparatuses.

3. The network printing system of claim 1, wherein the at least one terminal displays a list of image forming apparatuses having product property information that is substantially identical to product property information of the source image forming apparatus on a screen, designates one or more image forming apparatuses selected from the list as the target image forming apparatuses, and transmits the setting information to the target image forming apparatuses.

4. The network printing system of claim 1, wherein the at least one terminal stores the setting information in a host memory and transmits address information indicating an area of the host memory storing the setting information to the target image forming apparatuses so that the target image forming apparatuses read the setting information from the host memory.

5. The network printing system of claim 1, wherein the target image forming apparatuses communicate with the at least one terminal by multicasting using one of a Service Location Protocol, a Service Network Management Protocol, and a Common Network Management Protocol.

6. A terminal in communication with a plurality of image forming apparatuses through a network, the terminal comprising:
a user interface to input a command to copy setting information from a source image forming;
a communicator to request the setting information of the source image forming apparatus via the network and to receive the setting information from the source image forming apparatus;
a host memory to store the received setting information; and
a central processing unit to select a plurality of target image forming apparatuses and to control the communicator to transmit the setting information stored in the host memory to the plurality of target image forming apparatuses.

7. The terminal of claim 6, wherein the central processing unit collects product property information of each of the plurality of image forming apparatuses in the network to designate all image forming apparatuses having product property information that is substantially identical to product property information of the source image forming apparatus as the plurality of target image forming apparatuses.

8. The terminal of claim 7, further comprising:
a display to display a list of the image forming apparatuses having the product property information that is substantially identical to the product property information of the source image forming apparatus,
wherein the central processing unit designates image forming apparatuses selected from the displayed list as the plurality of target image forming apparatuses.

9. The terminal of claim 6, wherein the central processing unit controls the communicator to transmit address information indicating an area of the host memory storing the setting information to the plurality of target image forming apparatuses so that the plurality of target image forming apparatuses read the setting information from the host memory according to the address information.

10. The terminal of claim 6, wherein the setting information is transmitted to the plurality of target image forming apparatuses by multicasting using one of a Service Location Protocol, a Service Network Management Protocol, and a Common Network Management Protocol.

11. An image forming apparatus in communication with a terminal of a predetermined type via a network, the apparatus comprising:
a network interface to transmit and to receive predetermined data via the network;
a memory to store first setting information; and
a data processor to convert the first setting information into a first data file having a predetermined format and to control the network interface to transmit the first data file to the terminal if the network interface receives a request from the terminal designating the image forming apparatus as a source image forming apparatus.

12. The image forming apparatus of claim 11, wherein if a request received from the terminal designates the image forming apparatus as a target image forming apparatus, the data processor receives a second data file from the terminal, parses the second data file to detect second setting information, replaces the first setting information with the second setting information, and stores the second setting information in the memory.

13. The image forming apparatus of claim 12, wherein the first and second data files are written in one of an extensible Markup Language, a Web Services Description Language, a HyperText Markup Language, and a Standard Generalized Markup Language.

14. The image forming apparatus of claim 13, wherein the network interface communicates with the terminal by multicasting using one of a Service Location Protocol, a Service Network Management Protocol, and a Common Network Management Protocol.

15. A method of copying setting information in a network printing system, the method comprising:
selecting a source image forming apparatus from a plurality of image forming apparatuses of the network printing system;
sending setting information of the source image forming apparatus to a terminal connected to the network printing system upon receiving a request from the terminal;
storing the setting information in a host memory of the terminal;
designating one or more of the plurality of image forming apparatuses as target image forming apparatuses; and
communicating with the one or more target image forming apparatuses to transmit the setting information.

16. The method of claim 15, wherein the designating of the one or more of the plurality of image forming apparatuses as the target image forming apparatuses, comprises:
collecting product property information of each of the plurality of image forming apparatuses in the network printing system; and
designating image forming apparatuses having product property information that is substantially identical to product property information of the source image forming apparatus as the one or more target image forming apparatuses.

17. The method of claim 15, wherein the designating of the one or more of the plurality of image forming apparatuses as the target image forming apparatuses comprises:
displaying a list of image forming apparatuses having product property information that is substantially identical to product property information of the source image forming apparatus on a screen; and
selecting one or more image forming apparatuses from the list as the one or more target image forming apparatuses.

18. The method of claim 15, wherein the communicating with the one or more target image forming apparatuses to transmit the setting information comprises:
transmitting address information indicating an area of the host memory in which the setting information is stored to the one or more target image forming apparatuses; and
enabling the one or more target image forming apparatuses to read the setting information from the host memory of the terminal according to the address information.

19. The method of claim 15, wherein the setting information comprises information recorded in a data file using one of an extensible Markup Language, a Web Services Description Language, a HyperText Markup Language, and a Signed Document Markup Language.

20. The method of claim 19, wherein the terminal communicates with the one or more target image forming apparatuses by multicasting using one of a Service Location Protocol, a Service Network Management Protocol, and a Common Network Management Protocol.

21. A computer readable recording medium having executable codes to perform a method of copying setting information in a network printing system, the method comprising:
selecting a source image forming apparatus from a plurality of image forming apparatuses connected to a network;
requesting the setting information of the source image forming apparatus;
receiving the setting information from the source image forming apparatus;
designating one or more of the plurality of image forming apparatuses as target image forming apparatuses; and
communicating with the one or more target image forming apparatuses to transmit the setting information.

22. The computer readable recording medium of claim 21, wherein the designating of the one or more of the plurality of image forming apparatuses as the target image forming apparatuses, comprises:
retrieving product property information of each of the plurality of image forming apparatuses in the network printing system; and
designating image forming apparatuses of the plurality of image forming apparatuses having product property information that is substantially identical to product property information of the source image forming apparatus as the one or more target image forming apparatus.

23. The computer readable recording medium of claim 21, wherein the designating of the one or more of the plurality of image forming apparatuses as the target image forming apparatuses comprises:
displaying a list of image forming apparatuses having product property information that is substantially identical to product property information of the source image forming apparatus; and
selecting image forming apparatuses from the list as the one or more target image forming apparatuses.

24. The computer readable recording medium of claim 21, wherein the communicating with the one or more target image forming apparatuses is performed by multicasting using one of a Service Location Protocol, a Service Network Management Protocol, and a Common Network Management Protocol.

25. A network printing system comprising:
a plurality of image forming apparatuses, each having setting information, to provide the setting information upon request, and to replace the setting information with new setting information when the new setting information is received; and
a management unit in communication with the plurality of image forming apparatuses to select a source image forming apparatus from the plurality of image forming apparatuses, to request the setting information from the source image forming apparatus, to select at least two target image forming apparatuses from among the plurality of image forming apparatuses, and to provide the setting information of the source image forming apparatus to the at least two target image forming apparatuses in one transmission operation.

26. The network printing system of claim 25, wherein the management unit selects the at least two target information forming apparatuses based on product property information of the source image forming apparatus and product property information of each of the plurality of image forming apparatuses.

27. The network printing system of claim 26, wherein the product property information comprises manufacturing company names, types of products, series model names, and series model numbers.

28. A management module to manage image forming apparatuses of a network printing system, the management module comprising:
a user interface to display menus and lists of the image forming apparatuses, to select image forming apparatuses from the displayed lists, and to input commands according to the displayed menus;
a network interface to communicate with the image forming apparatuses; and
a controller to request setting information from a designated image forming apparatus, to select two or more image forming apparatuses from among the plurality of image forming apparatuses to simultaneously provide the setting information of the designated image forming apparatus to the two or more selected image forming apparatuses.

29. A management module to manage image forming apparatuses of a network printing system, the management module comprising:
a controller to copy a group of image forming apparatus settings from a source image apparatus to a group of target image forming apparatuses in parallel.

30. An image forming apparatus connected to a network having a plurality of image forming apparatus, the image forming apparatus comprising:
a controller to store current setting information, to provide the current setting information when requested by an external device, to receive new setting information in a packet according to a multicast protocol from the external device, to parse the new setting information from the packet, and to replace the current setting information with the new setting information.

31. A method to be performed in a network image printing system, comprising:
copying a group of image forming apparatus settings from a source image apparatus to a group of target image forming apparatuses in parallel.
